(19) United States
(12) Patent Application Publication
(10) Pub. No.: US 2015/0185770 A1
(43) Pub. Date: Jul. 2, 2015

(54) STOCK MATERIAL ENCLOSURE

(71) Applicant: Hewlett-Packard Development Company, L.P., Houston, TX (US)

(72) Inventors: Randall W. Martin, The Woodlands, TX (US); Sunny Hwang, London (GB); Morten Warren, London (GB)

(73) Assignee: Hewlett-Packard Development Company, L.P., Houston, TX (US)

(21) Appl. No.: 14/418,524

(22) PCT Filed: Sep. 28, 2012
(86) PCT No.: PCT/US12/57727

§ 371 Date: Jan. 30, 2015

(51) Int. Cl. G06F 1/16

(52) U.S. Cl. CPC G06F 1/1616; G06F 1/1615

(57) ABSTRACT

In various examples, systems, methods, and apparatus related to enclosures are described. The enclosure may include a display enclosure milled from a material having a thickness. The enclosure may also include an upper base milled from a material having a thickness. The display enclosure and the upper base may maintain the thickness.

### BACKGROUND

Computing devices including, for example, notebook computers, tablets, slates, desktop computers, computer displays, televisions, and others, utilize enclosures to house various electronic components. The enclosures may comprise a variety of materials and shapes which are generally manufactured in large quantities to enable mass production of the computing devices. The shape and size of enclosures are generally dictated by the electronic components included therein.

### BRIEF DESCRIPTION OF THE DRAWINGS

FIG. 1 is a view of a system in accordance with an example of the present disclosure;

FIGS. 2A-B are perspective views of materials comprising uniform thicknesses in accordance with the present disclosure;

FIG. 3 is a view of display enclosure in accordance with an example of the present disclosure;

FIG. 4 is a view of an upper base in accordance with an example of the present disclosure;

FIG. 5 is perspective view of a computing device in accordance with an example of the present disclosure; and

FIG. 6-7 illustrate flow diagrams in accordance with examples of the present disclosure.

### DETAILED DESCRIPTION

Computing devices such as notebook computers, tablet computers, slates, mobile phones, smart phones, televisions, and others utilize enclosures to house electronic components. The size and shape of the components may define the shape and size of the enclosures, which are often mass produced utilizing various techniques. These techniques may include injection molding, milling via computer numeric control (CNC), stamping materials, or other manners of forming an enclosure.

injection molding may utilize molds which form a negative of the desired enclosure. When the negative is injected with plastics or other materials and allowed to cure, an enclosure may be formed into a desired shape. While injection molding is conducive to mass production of cost efficient enclosures, any change in the enclosure after the molds have been produced, for example design changes, may result in a need for additional molds or alternations to a current mold. This may result in “downtime” in which enclosures cannot be produced.

With regards to the use of CNC, various devices, for example an end mill, may be used to reduce a billet or large block of material to a desired shape. The shape of the enclosure may be varied from one enclosure to another by varying parameters utilized to control the end mill. In general, the ability to vary designs quickly is gained, however, there is an added cost associated with the material which is wasted in the process.

in the present disclosure, systems, devices, and methods related to enclosures milled from sheet stock material having a generally uniform and post processing thickness are discussed. Sheet stock material, which may be referred to herein as simply material, is defined as a material uniform in one more aspects (e.g., structure, texture, and strength properties). The sheet stock material is manufactured to have a desired thickness, that in various implementations is uniform or consistent through a single sheet of material. Utilizing a material that is a correct or desired thickness for a finalized product facilitates a reduction in waste and cost. However, as a trend of smaller and thinner enclosures continues, milling enclosures from material having the desired thickness (i.e., thinness) produces additional issues, for example, overcoming warping effects. As will be used herein, a uniform thickness is a thickness that remains substantially consistent throughout a sheet of material.

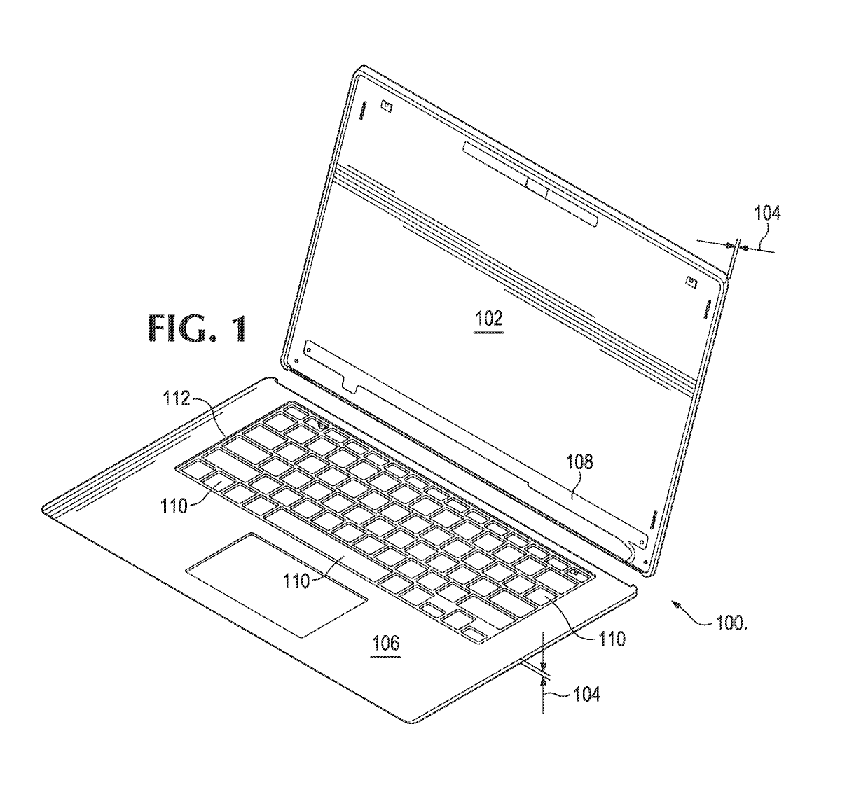

Referring to FIG. 1, a system is illustrated in accordance with one example of the present disclosure. The system 100 may be used as an enclosure for a notebook computing device. The system 100 comprises, a milled display enclosure 102 that is milled from a stock material having a manufactured thickness and a milled upper base 106 that is milled from the stock material having the manufactured thickness. Both the milled display enclosure 102 and the milled upper base 106 comprise a thickness 104 that is substantially equivalent to the manufactured thickness of the stock material, where substantially is defined as being within manufacturing tolerances (e.g. the ability of the manufacturing tools). In various examples, as will be discussed in more detail herein, the milled display enclosure 102 and the milled upper base 106 may be coupled to one another to form an enclosure for a notebook computing device.

The milled display enclosure 102 as used herein is an enclosure suitable for housing a display. Miffing, as used herein, is any process in which rotating tools (e.g., an end mill) or other tools are utilized to reduce an overall mass of material to form a desired product. The milled display enclosure 102 may be milled to include conduits, channels, or other access points 108 for cabling, electronics, or other devices associated with the system.

The milled upper base 106 as used herein is an enclosure suitable for housing a keyboard. It may be formed to couple with a lower base such that the upper base 106 and the lower base (not illustrated) may form an enclosure for electronics such as motherboards, hard disk drives (HDDs), optical drives, among others. In addition, the milled upper base 106 may be configured to house a force pad (not illustrated) to interface with the keyboard and receive indications of pressed keys/buttons. The milled upper base 106, in various examples, may have individual key recesses 110 milled into the milled upper base 106, or alternatively, may have a single area 112 to receive an entire keyboard milled into the surface.

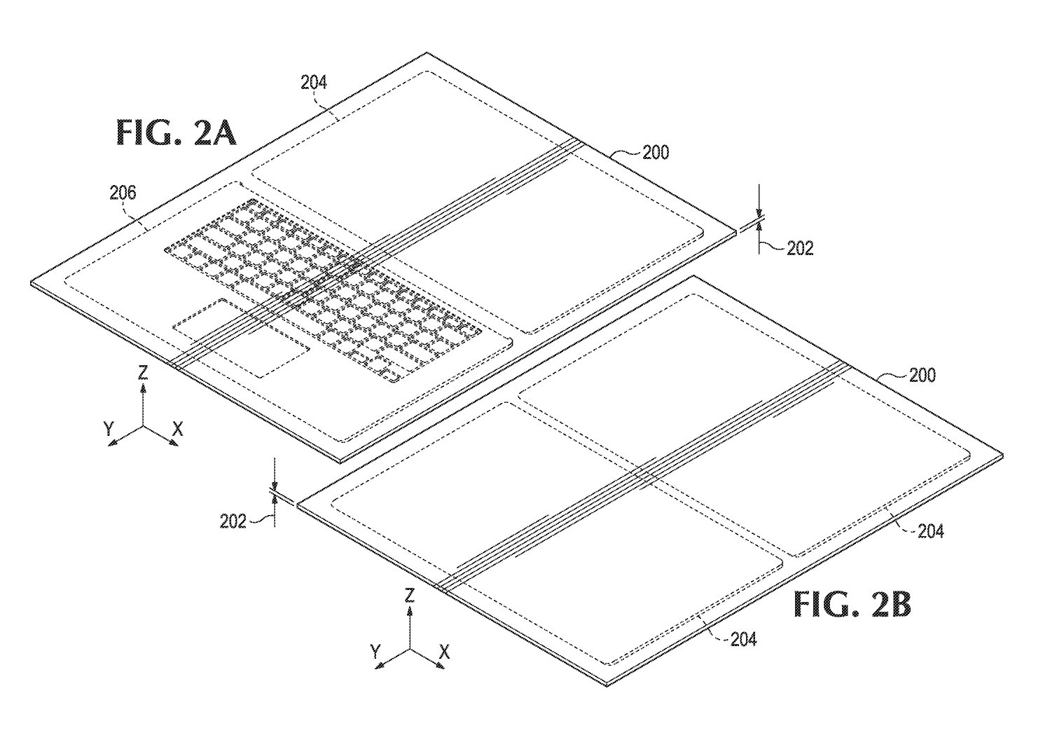

Referring to FIGS. 2A and 2B, perspective views of sheet stock material 200 suitable for producing the milled display enclosure and the milled upper base, as illustrated in FIG. 1, are illustrated in accordance with various examples. Within

FIGS. 2A and 2B, a single sheet of stock material 200 is illustrated, respectively. The sheet of stock material 200 may comprise uniform thickness 202 and other qualities such as strength, structure, or texture. Additionally, it is contemplated that the sheet stock material 200 may comprise a variety of materials such as aluminum, steel, carbon fiber, plastics, and wood among others. As illustrated, the sheet stock material 200 comprises three dimensions illustrated as x, y, and z. While two of these dimensions may be variable dependent upon various factors including the desired size of the sheet 200, limitations of the manufacturer or material, or the intended number of display enclosures or milled upper bases to be provided, a third dimension, i.e., the z dimension, is determined based upon a desired thickness of the manufactured product. In this manner, waste material in the z dimension may be minimized upon milling the sheet stock material into either the display enclosure or the milled upper base.

In various examples, to generate the milled display enclosure 204 and the milled upper base 206, a CNC process may be utilized. The CNC process may remove material from the milled display enclosure 204 in the z dimension and may remove material from the milled upper base 206 in the z dimension. The removed material may correspond to the dashed lines of FIGS. 2A and 2B. In addition to the removing material in the z dimension, the CNC process may also remove material in the x and y dimension. Removing material in the x and y dimension may enable an enclosure with a desired width and length suitable for varying sizes of screens, for example. The x and y dimensions may be varied in order to provide a predetermined number of components from a single sheet of stock material 200.

In FIG. 2A, a sheet of stock material 200 is illustrated having a uniform thickness 202. The uniform thickness 202, in various examples, may be approximately 3.75 mm. Other thicknesses are contemplated. Within the sheet of stock material 200, a milled display enclosure 204 and a milled upper base 206 may be produced. In this manner a single sheet of stock material 200 may provide both the milled display enclosure 204 and the milled upper base 206. Having the display enclosure 204 and the upper base 206 generated from a single sheet of stock material 200 generally provides that both the display enclosure 204 and the upper base 206 will be consistent in aesthetics, strength properties, and response to environmental conditions,

Referring to FIG. 2B, another sheet of stock material 200 is illustrated having a uniform thickness 202. Again, the thickness of the stock material 200 may be determined based upon an intended thickness of either the display enclosure or the upper base. However, in contrast to FIG. 2A, this example illustrates that multiple display enclosures 204 may be produced from a single sheet of stock material 200. In other examples, multiple upper bases may be produced from a single sheet of stock material. Having a single component (i.e. two display enclosures 204) generated from a sheet of stock material 200 generally provides the ability to have one component, for example a display enclosure 204, generated from a first material (e.g., aluminum), and a second component, for example a upper base 204, generated from a second material (e.g., plastic). Again, waste generated from a milling process may be minimized by incorporating a desired thickness 202 into the sheet stock material 200 prior to production of the individual components.

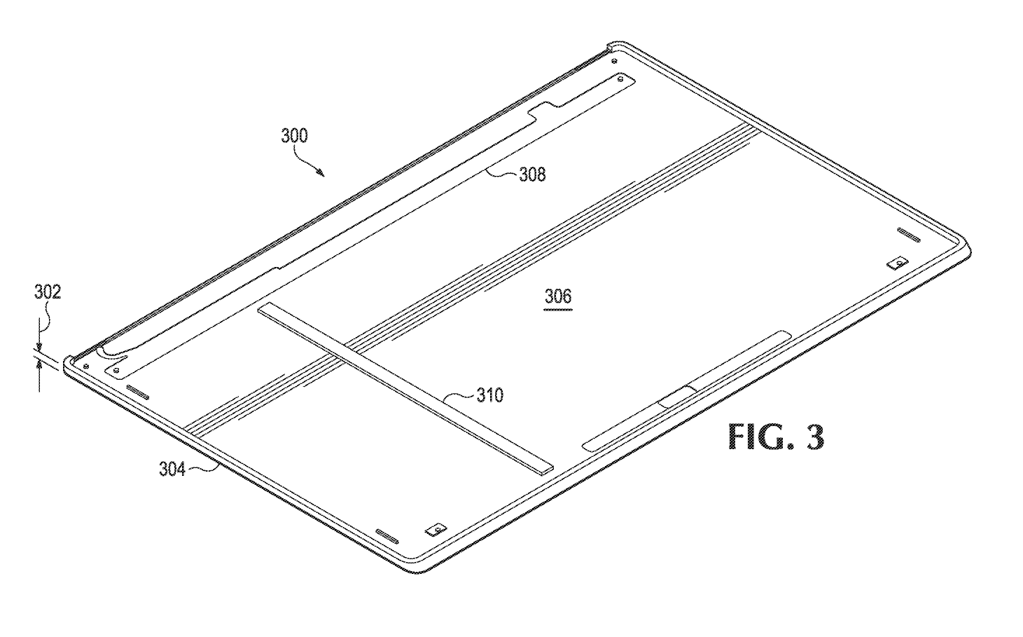

Referring to FIG. 3, a milled display enclosure 300 is illustrated in accordance with an example of the present disclosure. The milled display enclosure 300 is milled from a stock material having manufactured or uniform thickness 302, for example the stock material illustrated in FIGS. 2A-2B. The display enclosure 300 is milled to accept a display and maintains the uniform thickness 302 of the stock material around a periphery of the display, as indicated by bezel 304. The thickness 302 of the display enclosure 300 may vary throughout the display enclosure to ensure space 306 for the display (not illustrated) and space 308 for corresponding and other components (not illustrated) that may be included or housed within the display enclosure 300, for example, antennas, cameras, and lights.

In various examples, the milled display enclosure 300 may be milled to include one or more ribs 310. A rib 310, as used herein, is a structure integral with the display enclosure 300 that increases the rigidity of the display enclosure 300. The ribs 310 may be milled in a pattern such as a cross hatch patter, vertical ribs (as illustrated), horizontal ribs, and may be included where the display and corresponding electronic components permit.

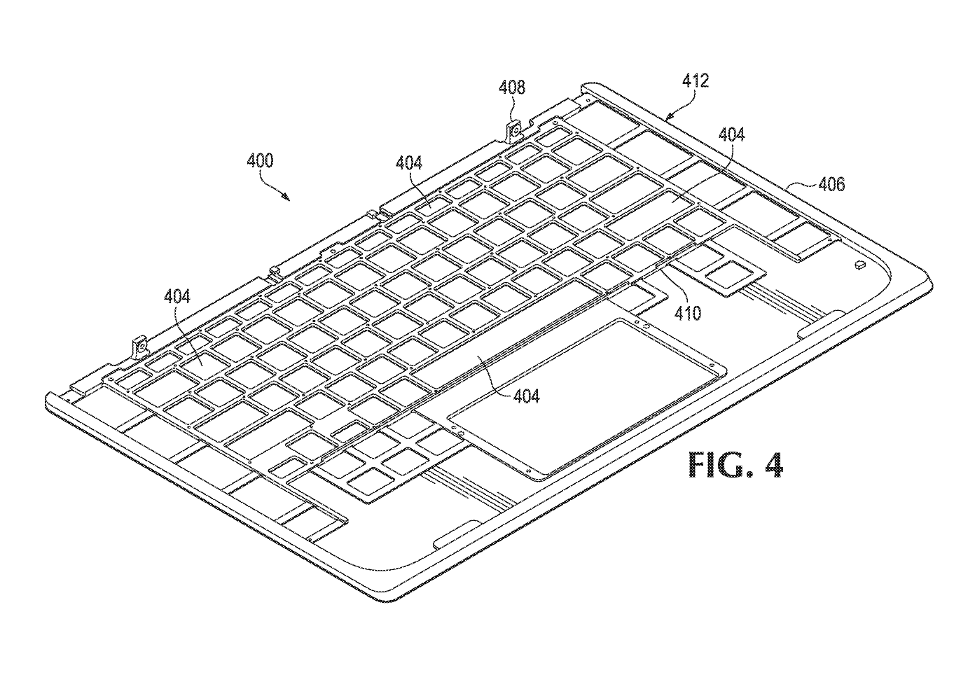

Referring to FIG. 4, a milled upper base 400 is illustrated in accordance with an example of the present disclosure. The milled upper base 400, in various examples, is to couple to the display enclosure via one or more hinges (not illustrated) that may or may not attach to components integral with the milled upper base 400. The milled upper base 400 is milled from a manufactured sheet of stock material comprising a manufactured or uniform thickness 402, and is further configured to accept a keyboard 404. The milled portion of the upper base 400 may, in some examples, be further milled to accept a force pad which is to receive indications of key presses from the keyboard. In various examples, the depth of the mill into the milled upper base 400 may be varied dependent upon the type of keyboard utilized.

The milled upper base 400 may be milled to accept various keyboards. For example, in some implementations, the milled upper base 400 may have individual keyholes 404 milled to receive individual keys. In other implementations, illustrated more clearly in FIG. 1, a single window (112) may be milled to receive an entire keyboard. In either example, the milled upper base 400 is to maintain the uniform thickness around a periphery of the keyboard indicated by arrow 406. In addition to various windows or keyholes 404 to receive keys and/or a keyboard, the milled upper base 400 may be milled to include additional features include mountings 408 for a lower base (not illustrated) and ribs 410 similar to the ribs discussed with reference to FIG. 3. In one example, the milled upper base 400 is milled to include rails 412 on which a lower base may mount in sliding engagement. Once engaged, a lower base may be secured into place via one or more fastener which may interface with mountings 408.

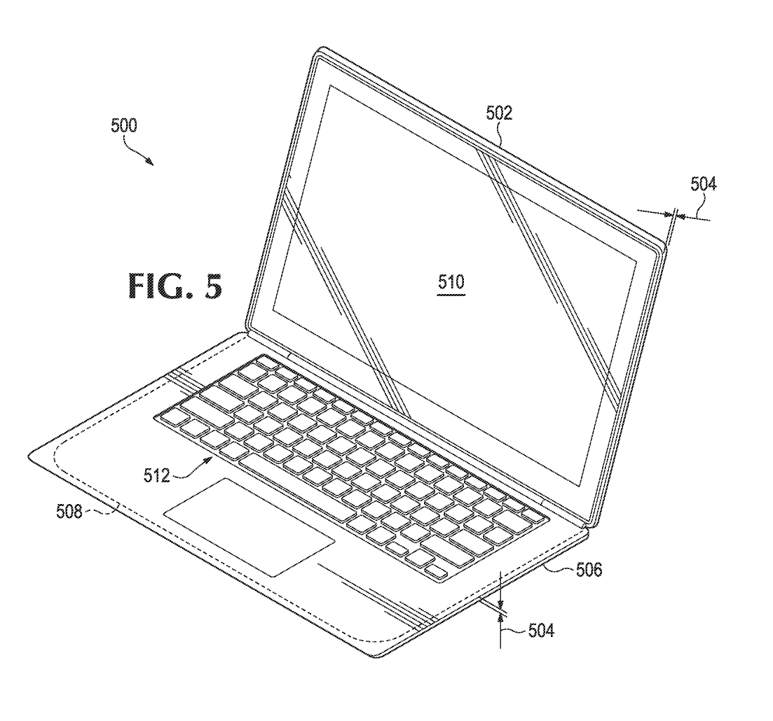

Referring to FIG. 5, a computing device 500 is illustrated in accordance with example. The computing device of FIG. 5 comprises a display enclosure 502 milled from a manufactured stock material comprising a uniform thickness 504, an upper base 506 coupled to the display enclosure 502 and milled from the manufactured sheet of stock material comprising the uniform thickness 504, and a lower base 508 (illustrated as dashed lines) coupled to the upper base, wherein the lower base 508 is to house a plurality of components.

As illustrated, the computing device includes a display 510 mounted within the display enclosure 502 and a keyboard 512 mounted within the upper base 506. Interfacing with the display 510 and the keyboard 512 are a plurality of electronics (not illustrated) housed within the lower base 508. The lower base 508, as illustrated has a surface area that is less than the surface area of the upper base 506 and is therefore hidden beneath the upper base 506 when viewed from an elevated perspective. The hidden lower base 508 has the effect of making the overall computing system 502 appear as a device having a thickness based on the manufactured or uniform thickness 504 of the sheet stock material, that is, twice the uniform thickness when viewed in a closed position.

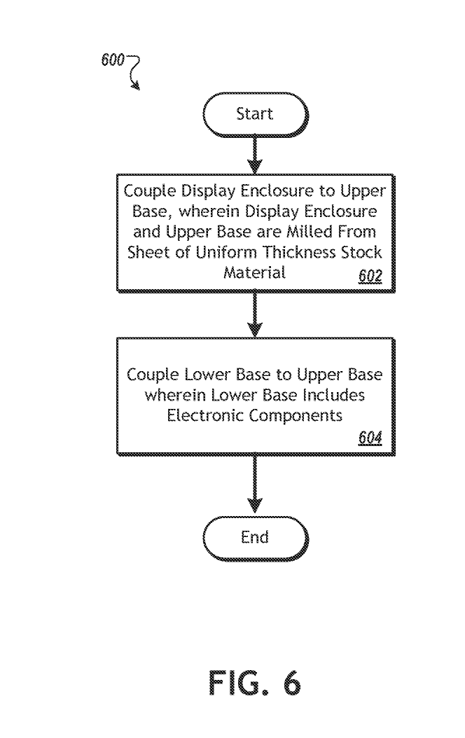

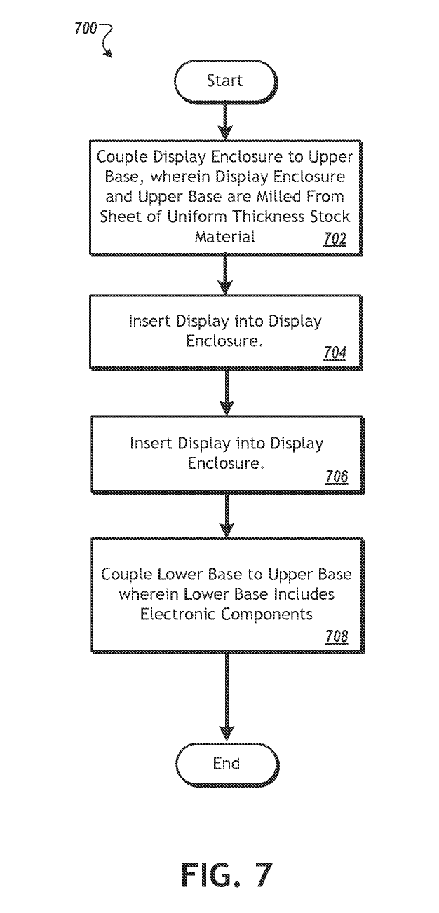

Referring to FIGS. 6 and 7 flow diagrams are illustrated in accordance with various examples of the present disclosure. The flow diagrams, while illustrated in a particular order, are not intended to be limited to any temporal restrictions. Rather, it is expressly contemplated that various elements may occur before, after, or simultaneously with others.

Referring to FIG. 6, the flow diagram may begin and progress to 602 where a display enclosure, for example a display enclosure as illustrated in the previous figures, is coupled to an upper base. In various examples, both the display enclosure and the upper base are milled from sheet of stock material having a substantially uniform thickness, wherein substantially is defined with respect to the capabilities of the manufacturing tools. The display enclosure and the upper base may be milled from a single sheet stock material as illustrated in FIG. 2A, or alternatively, may have been milled from separate sheets of stock material as illustrated in FIG. 2B. Additionally, while the stock material may comprise a uniform thickness, the stock material for the display enclosure may vary from the stock material for the upper base.

At 604, a lower base may be coupled to the upper base. In various examples, the lower base may include a plurality of electronic components and comprise a surface area that is less than a surface area of the upper base. In this manner, when the lower base is coupled 10 the upper base, the lower base may be hidden from view when viewed from a majority of viewing angles. The lower base, may be of a similar or different material, for example, in one embodiment, the lower base is a steel base that may be coated in plastics or rubber to increase friction of the computing system. Other materials are contemplated. The method may then end.

Referring to FIG. 7, the flow diagram may begin and progress to 702 where a display enclosure, for example a display enclosure as illustrated in FIGS. 1-5, is coupled to an upper base. In various examples, both the display enclosure and the upper base are milled from sheet of stock material having a substantially uniform thickness. The display enclosure and the upper base may be milled from a single sheet stock material as illustrated in FIG. 2A, or alternatively, may have been milled from separate sheets of stock material as illustrated in FIG. 2B. Additionally, while the stock material may comprise a uniform thickness, the stock material for the display enclosure may vary from the stock material for the upper base.

At 704, a display may be inserted into the display enclosure. In various examples, the display may be a liquid crystal display (LCD), a light emitting diode display (LED), an organic light emitting diode (OLED) display, or any other type of display configured for use with computing systems. The display enclosure may be milled to accept the display within a certain tolerance, and may include various features milled into the display enclosure to account for a specific shape of the display.

At 706, a keyboard may be inserted into the upper base of the computing system. The keyboard may comprise any type of keyboard known in the art, and in various examples, may include other components such as but not limited to a force pad.

Upon insertion of the display at 704 and the keyboard at 706, a lower base may be coupled to the upper base at 708. In various examples, the lower base may include a plurality of electronic components and comprise a surface area that is less than a surface area of the upper base. In this manner, when the lower base is coupled to the upper base, the lower base may be hidden from view when viewed from a majority of viewing angles. The lower base, may be of a similar or different material, for example, in one embodiment, the lower base is a steel base that may be coated in plastics or rubber to increase friction of the computing system. Other materials are contemplated.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of this disclosure, Those with skill in the art will readily appreciate that embodiments may be implemented in a wide variety of ways. This application is intended to cover any adaptations or variations of the embodiments discussed herein. Therefore, it is manifestly intended that embodiments be limited only by the claims and the equivalents thereof.

What is claimed is:

1. A system, comprising:
a milled upper base enclosure milled from a stock material having a manufactured thickness, wherein the milled upper base enclosure is to receive a keyboard and comprises a thickness substantially equivalent to the manufactured thickness.

2. The system of claim 1, further comprising:
a display enclosure milled from a stock material comprising a uniform thickness, wherein the display enclosure is milled to accept a display and maintains the uniform thickness around a periphery of the display.

3. The system of claim 2, wherein the milled upper base enclosure and the milled display enclosure are each milled from a single sheet of the stock material comprising the manufactured thickness.

4. The system of claim 1, wherein the milled upper base enclosure and the milled display enclosure are milled from a different sheet of the stock material having the manufactured thickness.

5. The system of claim 1, wherein the uniform thickness is approximately 3.75 mm.

6. The system of claim 1, further comprising:
a lower base configured to house a plurality of electronic devices and engage the milled upper base enclosure in a sliding manner.

7. A portable computing device, comprising:
a display enclosure milled from a manufactured sheet of stock material comprising a uniform thickness, wherein the display enclosure is milled to accept a display and maintains the uniform thickness around a periphery of the display;
an upper base coupled to the display enclosure and milled from the manufactured sheet of stock material comprising the uniform thickness, wherein the upper base is milled to accept a keyboard and maintains the uniform thickness around a periphery of the keyboard; and
a lower base coupled to the upper base, wherein the lower base is to house a plurality of electronic components to interface with the keyboard and the display, the lower base comprising a surface area that is less than the upper base,

8. The portable computing device of claim 7, further comprising:
the display coupled to the display enclosure; and
the keyboard coupled to the upper base.

9. The portable computing device of claim 7, wherein the display enclosure and the upper base include a plurality of ribs to increase a rigidity of the portable computing device.

10. The portable computing device of claim 7, wherein the manufactured sheet of stock material is aluminum.

11. The portable computing device of claim 7, wherein the manufactured sheet of stock material is plastic.

12. The portable computing device of claim 7, wherein the upper base is further milled to accept the lower base in sliding engagement.

13. A method, comprising:
coupling a display enclosure to an upper base, wherein the display enclosure and the upper base are milled from a sheet of uniform thickness stock material and a thickest portion of both the display enclosure and the upper base are substantially equal to the uniform thickness; and
coupling a lower base to the upper base, wherein the lower base includes a plurality of electronic components and comprises a surface area that is less than a surface area of the upper base.

14. The method of claim 13, further comprising:
inserting a display into the display enclosure, wherein the display has a thickness that is less than the uniform thickness.

15. The method of claim 13, further comprising:
inserting a keyboard into the upper base, wherein a thickness of the keyboard is less than the uniform thickness.
